(19) United States
(12) Patent Application Publication
(10) Pub. No.: US 2011/0154413 A1
(43) Pub. Date: Jun. 23, 2011

(54) SYSTEM FOR PROVIDING MULTIMEDIA DATA USING HUMAN BODY COMMUNICATION IN TRANSPORTATION

(75) Inventors: Kyung Hwan PARK, Daejeon (KR); Sung Weon Kang, Daejeon (KR); In Gi Lim, Daejeon (KR); Kyung Soo Kim, Daejeon (KR); Jung Bum Kim, Daejeon (KR); Seok Bong Hyun, Daejeon (KR); Tae Young Kang, Daejeon (KR); Tae Wook Kang, Daejeon (KR); Hyung Il Park, Daejeon (KR); Sung Eun Kim, Seoul (KR); Byoung Gun Choi, Daegu (KR); Chang Hee Hyoung, Daejeon (KR); Jung Hwan Hwang, Daejeon (KR)

(73) Assignee: Electronics and Telecommunications Research Institute, Daejeon (KR)

(21) Appl. No.: 12/951,970

(22) Filed: Nov. 22, 2010

(30) Foreign Application Priority Data
Dec. 22, 2009 (KR) 10-2009-0129269
Jun. 3, 2010 (KR) 10-2010-0052447

(51) Int. Cl. H04N 7/18

(52) U.S. Cl. 725/75

(57) ABSTRACT

Disclosed is a system for providing multimedia data using human body communication in transportation capable of improving user convenience in transportation and providing various multimedia data. The system for providing multimedia data using human body communication in transportation includes: a multimedia data providing device converting multimedia data into a signal available for human communication and transmitting the converted signal to one or more of conductive units installed within transportation; and a human body communication device receiving the multimedia data through a user's body brought into contact with the one or more conductive units and executing the received multimedia data.

### CROSS-REFERENCE TO RELATED APPLICATIONS

This application claims the priority of Korean Patent Application Nos. 10-2009-0129269 filed on Dec. 22, 2009 and 10-2010-0052447 filed on Jun. 3, 2010, in the Korean Intellectual Property Office, the disclosures of which are incorporated herein by reference.

### BACKGROUND OF THE INVENTION

1. Field of the Invention

The present invention relates to the provision of multimedia data in transportation and, more particularly, to a system for providing multimedia data using human body communication in transportation capable of improving user convenience by using human body communication and providing a multimedia service having multiple channels.

2. Description of the Related Art

In general, some passengers using public transportation such as buses, subways, and the like, tend to read newspapers or books or play games with mobile phones, or the like, even for a short time, in order to keep themselves occupied. Other passengers, those without contents ready to hand, may view advertisements posted around or vehicle TVs.

As a media information service provided in public transportation such as buses, subways, trains, and the like, a single channel service such as a voice announcement (or broadcast) through speakers installed in vehicles, radio broadcast outputs, or advertisements (or commercials), news, stop guidance, movies, and the like, through display devices installed in vehicles, is largely provided.

Alternatively, airplanes, high-speed trains, and the like, provide services allowing users to manipulate a multimedia device installed in each of seats to selectively receive music or video channels.

However, the media services provided in the foregoing public transportation are merely unidirectional services largely including a single channel or simply deliver the same or repetitive information in relation to the operation of transportation, resulting in boredom for passengers using transportation. Even in a case in which the passengers read books or newspapers or use a mobile terminal, when there are a large amount of passengers or when the vehicle jiggles severely, passengers must brace themselves with the handles or bars installed in the vehicle, causing user inconvenience.

Also, the advancement of mobile communications technology allows for the use of various contents using the wireless Internet, or the like, even in public transportation; however, the cost for accessing wireless Internet services and using contents are burdensome, and a wireless LAN whose cost is a relatively low does not provide a smooth service due to the shortage of wireless channels in an environment in which users are crowded, such as in public transportation.

### SUMMARY OF THE INVENTION

An aspect of the present invention provides a system for providing multimedia data using human body communication in transportation capable of improving user convenience in transportation and providing various types of multimedia data.

According to an aspect of the present invention, there is provided a system for providing multimedia data using human body communication in transportation, including: a first controller acquiring multimedia data and providing acquired multimedia data; a first human body communication unit converting the multimedia data into a signal available for human body communication and then providing the converted signal to one or more conductive members installed In transportation; and a storage unit storing the multimedia data.

The first controller may provide control to provide different types of multimedia data to each of the one or more conductive members installed in transportation.

The system may further include: an output unit displaying data provided through human body communication, wherein when data is provided through human body communication, the first controller controls the output unit to display the provided data.

The one or more conductive members may be installed in at least one of a handle, vertical bar and horizontal bar installed within transportation.

The system may further include: a wireless communication unit performing radio communication under the control of the first controller.

When Internet access information is provided, the first controller may provide control to access a corresponding server via the wireless communication unit and transmit data provided from the corresponding server through human body communication.

According to another aspect of the present invention, there is provided a system for providing multimedia data using human body communication in transportation, including: a second human body communication unit receiving multimedia data transmitted through a user's body and providing the received multimedia data; a second controller receiving the multimedia data and controlling the execution of the received multimedia data; and a multimedia data processing unit executing the multimedia data under the control of the second controller.

The system may further include: an input unit receiving data from a user; and an output unit outputting execution results of the multimedia data, wherein when data is provided through the input unit, the second controller may control the second human body communication unit to transmit the provided input data through human body communication.

According to another aspect of the present invention, there is provided a system for providing multimedia data using human body communication in transportation, including: a multimedia data providing device converting multimedia data into a signal available for human communication and transmitting the converted signal to one or more of conductive units installed within transportation; and a human body communication device receiving the multimedia data through a user's body brought into contact with the one or more conductive units and executing the received multimedia data.

The human body communication device may convert information provided from a user into a signal available for human body communication and provide the converted signal to the one or more conductive units brought into contact with the user's body.

The multimedia data providing device may access a corresponding Web server according to Internet access information provided from the human body communication device, convert data provided from the accessed Web server into a signal available for human body communication, and provide the converted signal to the human body communication device.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a conceptual view for explaining a system for providing multimedia data using human body communication in transportation according to an exemplary embodiment of the present invention;

FIG. 2 is a schematic block diagram of the system for providing multimedia data using human body communication in transportation according to an exemplary embodiment of the present invention;

FIG. 3 is a conceptual view for explaining a system for providing multimedia data using human body communication in transportation according to another exemplary embodiment of the present invention;

FIG. 4 is a schematic block diagram of the system for providing multimedia data using human body communication in transportation according to another exemplary embodiment of the present invention;

FIG. 5 is a conceptual view for explaining a system for providing multimedia data using human body communication in transportation according to still another exemplary embodiment of the present invention; and

FIG. 6 is a schematic block diagram of the system for providing multimedia data using human body communication in transportation according to a still another exemplary embodiment of the present invention.

### DETAILED DESCRIPTION OF THE PREFERRED EMBODIMENT

The present invention may be modified variably and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components are rendered using the same reference number that are the same or are in correspondence, regardless of the figure number, and redundant explanations are omitted.

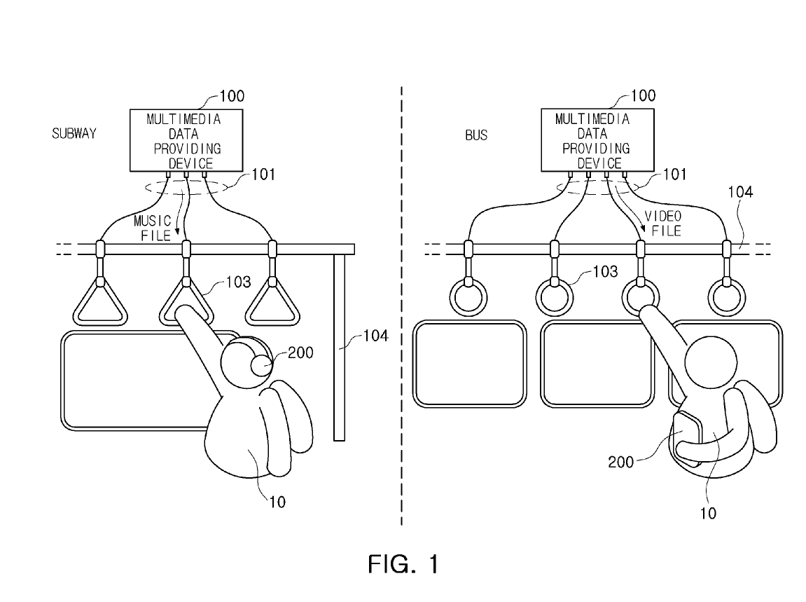

FIG. 1 is a conceptual view for explaining a system for providing multimedia data using human body communication in transportation according to an exemplary embodiment of the present invention.

With reference to FIG. 1, the system for providing multimedia data using human body communication in transportation according to an exemplary embodiment of the present invention may include a multimedia data providing device 100 installed in transportation such as a bus, a subway, or the like, and a human body communication device 200 held by a user, receiving multimedia data through human body communication with the multimedia data providing device 100, and executing the received multimedia data to provide a multimedia service to the user.

Here, human body communication is a communication scheme in which current flows directly into devices attached to a human body or an electric field is formed therebetween by using the human body as a transmission medium to thus allow for data transmission and reception therebetween. Because human body communication uses baseband signals of 30 MHz or lower, without using carriers, and secures a data transfer rate of hundreds of kbps to scores of Mbps according to modulation schemes, it is utilized for high speed radio communications, and various applications using human body communication are being generated.

The multimedia data providing device 100 converts multimedia data such as music, video, and the like, into a transmission signal fitting a human body communication standard, and then transmits the converted transmission signal to a contact terminal of a handle 103 or a vertical or horizontal bar 104 installed in transportation to allow the user to come in contact therewith through a communication line 101 installed within transportation.

When the user holds the handle 103 or the vertical bar 104, multimedia data is transferred from the hand in contact with the handle 103 or the vertical bar 104 to the human body communication device 200 (e.g., a headset, a mobile phone, a PDA, a PMP, or the like) in contact with the user's body, to allow the user to listen to music or view a video, and the like.

Here, when the user uses a headset, the human body communication device 200 carried by the user needs to be maintained in contact with the user's skin in order to maintain human body communication between the multimedia data providing device 100 and the human body communication device (namely, the headset 200). Thus, a human body communication receiver may be embedded in the headset that can constantly come into contact with the user's body near a user's ear, so that the user can directly listen to music without having to use earphones.

Also, when the user carries around the human body communication device 200 including a display device, the user is required to hold the human body communication device 200 in hand. Thus, in consideration of this, the position of the contact terminal in the human body communication device 200 may be determined.

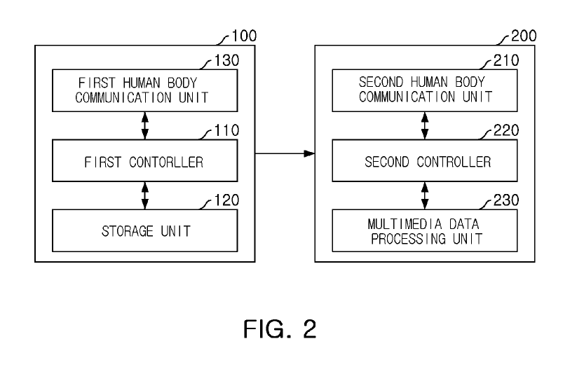

FIG. 2 is a schematic block diagram of the system for providing multimedia data using human body communication in transportation according to an exemplary embodiment of the present invention.

With reference to FIG. 2, the multimedia data providing device 100 may be installed in transportation and include a first controller 110, a storage unit 120, and a first human body communication unit 130.

In order to provide multimedia data through human body communication in transportation, the first controller 110 reads multimedia data from the storage unit 120 and then provides the read multimedia data to the first human body communication unit 130, so that the multimedia data can be provided to a conductive member (or an electrode) installed in the handle 103, or the vertical bar or horizontal bar 104 within transportation.

Here, the first controller 110 may transmit the same multimedia data to the conductive members installed in the plurality of handles 103 or the bars 104 installed in transportation, or transmit different types of multimedia data to the conductive members installed in the plurality of handles 103 or the bars 104. For example, the first controller 110 may transmit different types of multimedia data such as a broadcast, an advertisement, music, news, business entertainment, sports, operation lines, operation time, location information, and the like, to each of the plurality of handles 103 or bars 104 installed within transportation.

The storage unit 120 stores the multimedia data such as music, video, text, and the like, to be provided within transportation.

The first human body communication unit 130 converts the multimedia data provided from the first controller 110 into a standard fitting human body communication and then transmits the converted data through channels installed within transportation.

Here, the first human body communication unit 130 may transmit the same multimedia data to the plurality of channels or transmit different types of multimedia data to each of the plurality of channels under the control of the first controller 110.

Also, although not shown, the first human body communication unit 130 may be connected to a plurality of communication lines (namely, channels) installed within transportation, and the ends of the plurality of communication lines may be connected to the conductive members (or electrodes) installed in the handles 103 or the bars 104 that can be directly contacted by the user.

The human body communication device 200, which may be carried around by each user, includes a second human body communication unit 210, a second controller 220, and a multimedia data processing unit 230.

When the user comes into contact with the conductive member installed in the handle 103, the bar 104, or the like, within transportation, the second human body communication unit 210 receives multimedia data transmitted through the user's body, processes the received multimedia data, and provides the processed data to the second controller 220. To this end, the second human body communication unit 210 includes an electrode (not shown) to be contacted by the user's body.

The second controller 220 receives the multimedia data from the second human body communication unit 210 and provides the received multimedia data to the multimedia data processing unit 230, and controls the multimedia data processing unit 230 to execute the multimedia data.

The multimedia data processing unit 230 executes the provided multimedia data under the control of the second controller 220. To this end, the multimedia data processing unit 230 may include a decoding module for decoding coded voice or image data.

Also, although not shown in FIG. 2, the human body communication device 200 may include an output element (e.g., a speaker, a headphone/earphone terminal, a display) for outputting the multimedia data provided from the multimedia data providing device 100, and the output element may output a signal provided from the multimedia data processing unit 230.

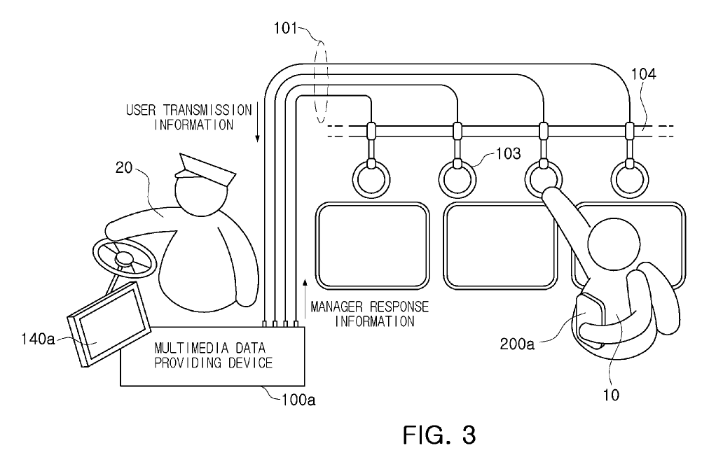

FIG. 3 is a conceptual view for explaining a system for providing multimedia data using human body communication in transportation according to another exemplary embodiment of the present invention. Specifically, FIG. 3 shows a multimedia data providing system available for bi-directional communication.

With reference to FIG. 3, human body communication can be performed bi-directionally according to a time-division scheme. Thus, it may be configured such that information transmitted by the user through the human body communication device 200a is displayed on a display unit 140a of an operator or manager 20.

That is, the user may previously create information to be transmitted by using his human body communication device 200a. And then, when the user holds the nearby handle 103 or the bar 104, the created information may be transmitted to the multimedia data providing device 100a through human body communication. Then, a display unit 140a of the multimedia data providing device 100a may display the information which has been transmitted by the user, and the operator or manager 20 can take a proper measure.

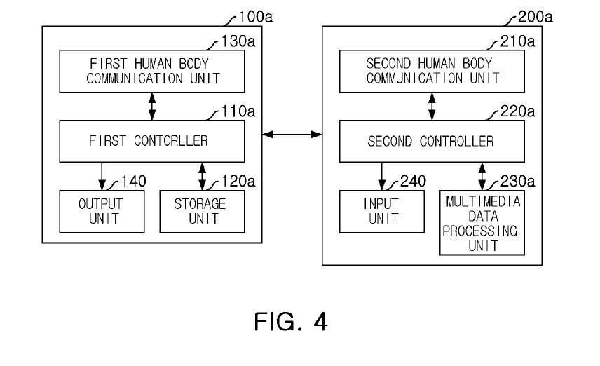

FIG. 4 is a schematic block diagram of the system for providing multimedia data using human body communication in transportation according to another exemplary embodiment of the present invention.

With reference to FIG. 4, the multimedia data providing device 100a may include a first controller 110a, a storage unit 120a, a first human body communication unit 130a, and an output unit 140.

In order to provide multimedia data through human body communication in transportation, the first controller 110a reads multimedia data from the storage unit 120a and then provides the read multimedia data to the first human body communication unit 130a, so that the multimedia data can be provided to a conductive member installed in the handle 103, or the vertical bar or horizontal bar 104 within transportation.

Here, the first controller 110a may transmit the same multimedia data to the plurality of handles 103 or the bars 104 installed in transportation, or transmit different types of multimedia data to the plurality of handles 103 or the bars 104.

When data is provided from the human body communication device 200a through human body communication, the first controller 110a processes the data provided through the first human body communication unit 130a and provides the processes data to the output unit 140, so that the provided data can be output to the output unit 140.

The storage unit 120a stores multimedia data such as music, video, text, and the like, to be provided within transportation.

The first human body communication unit 130a converts the multimedia data provided from the first controller 110a into a standard fitting human body communication and then transmits the converted data through channels installed within transportation. Also, the first human body communication unit 130a receives data transmitted from the human body communication unit 200a through channels installed within transportation, processes the received data, and provides the processed data to the first controller 110a.

Here, the first human body communication unit 130a may transmit the same multimedia data to the plurality of channels or transmit different types of multimedia data to each of the plurality of channels under the control of the first controller 110.

Also, the first human body communication unit 130a may be connected to a plurality of communication lines (namely, channels) installed within transportation, and the ends of the plurality of communication lines may be connected to the conductive members installed in the handles 103 or the bars 104 that can be directly contacted by the user.

The output unit 140 outputs the provided data according to the data and a control signal provided from the first controller 110a. Here, the output unit 140 may be implemented in various known forms. For example, the output unit 140 may be configured to include a display unit and an image processing module for driving the display unit to display the data provided from the human body communication unit 200a. Alternatively, the output unit 140 may be configured to include a speaker, a signal conversion module, and a signal amplification module to output a voice or an audio signal corresponding to the provided data.

The human body communication device 200a may include a second human body communication unit 210a, a second controller 220a, a multimedia data processing unit 230a, and an input unit 240.

When the user comes into contact with the conductive member installed in the handle 103, the bar 104, or the like, within transportation, the second human body communication unit 210a receives multimedia data transmitted through the user's body, processes the received multimedia data, and provides the processed data to the second controller 220a. To this end, the second human body communication unit 210a includes an electrode (not shown) to be contacted by the user's body.

The second controller 220a receives the multimedia data from the second human body communication unit 210a and provides the received multimedia data to the multimedia data processing unit 230a, and controls the multimedia data processing unit 230a to execute the multimedia data.

Also, the second controller 220a provides the data provided from the input unit 240 to the second human body communication unit 210a and controls the second human body communication unit 210a to transmit the data to the multimedia data providing device 100a through human body communication. Here, the data may be information desired to be sent to the manager or operator of the vehicle upon which data consumers are traveling, and may have a text message format including emergency information, inquiry information, a channel change request, a temperature adjustment request, a billing information inquiry, and the like.

The multimedia data processing unit 230a executes the provided multimedia data under the control of the second controller 220a. To this end, the multimedia data processing unit 230a may include a decoding module for decoding a coded voice or image data.

The input unit 240 may be configured as a keypad, a touch pad, a touch screen, or the like. The input unit 240 provides data generated according to a user's key manipulation to the second controller 220a.

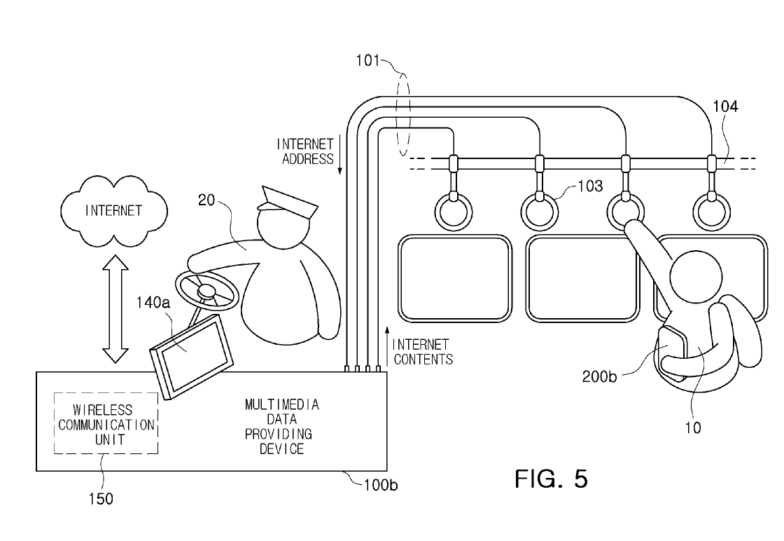

FIG. 5 is a conceptual view for explaining a system for providing multimedia data using human body communication in transportation according to still another exemplary embodiment of the present invention. Specifically, FIG. 5 shows a case of providing an Internet access service.

With reference to FIG. 5, when the user 10 accesses the Internet by using a Web browser in a human body communication device 200b, Internet address information inputted by the user is transmitted to the multimedia data providing device 100b through human body communication. The multimedia data providing device 100b is connected to a Web server corresponding to the Internet address information through a wireless communication unit 150, receives Internet data from the connected Web server, processes the received Internet data such that it fits human body communication, and then transmits the processed data to the human body communication device 200b.

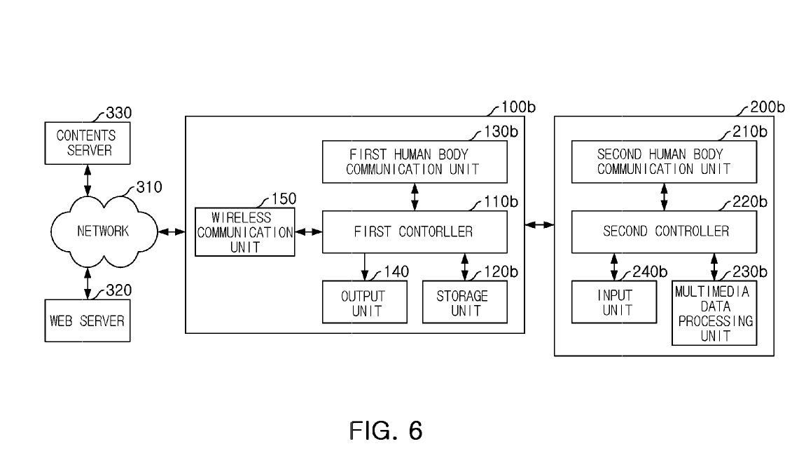

FIG. 6 is a schematic block diagram of the system for providing multimedia data using human body communication in transportation according to a still another exemplary embodiment of the present invention.

With reference to FIG. 6, a multimedia data providing device 100b may include a first controller 110b, a storage unit 120b, a first human body communication unit 130b, an output unit 140, and a wireless communication unit 150.

In order to provide multimedia data through human body communication in transportation, the first controller 110b reads multimedia data from the storage unit 120b and then provides the read multimedia data to the first human body communication unit 130b, so that the multimedia data can be provided to a conductive member installed in the handle 103, or the vertical bar or horizontal bar 104 within transportation.

Alternatively, the first controller 110b may access an external contents server 330 through the wireless communication unit 150 to receive multimedia data from the contents server 330, and provide the received multimedia data to the human body communication device 200b.

Alternatively, when Internet access information is provided from the human body communication device 200b through the first human body communication unit 130b, the first controller 110b provides the Internet access information to the wireless communication unit 150, controls the wireless communication unit 150 to access a corresponding Web server, and provides control to provide Internet data provided from the Web server to the human body communication device 200b through human body communication. Here, the Internet access information may include all information required for accessing the Internet, such as an access request message for an Internet access, a destination address, a port number, and the like.

The first controller 110b may transmit the same multimedia data to the plurality of handles 103 or the bars 104 installed in transportation, or transmit different types of multimedia data to the plurality of handles 103 or the bars 104.

The storage unit 120b stores multimedia data such as music, video, text, and the like, to be provided within transportation.

The first human body communication unit 130b converts the multimedia data provided from the first controller 110b into a standard fitting human body communication and then transmits the converted data through channels installed within transportation. Also, the first human body communication unit 130b receives Internet access information transmitted from the human body communication unit 200b through channels installed within transportation, processes the received Internet access information, and provides the processed Internet access information to the first controller 110b.

Here the first human body communication unit 130b is connected to the plurality of communication lines (namely, channels) installed within transportation, and the ends of the plurality of communication lines may be connected to the conductive members installed in the handles 103 or the bars 104 that can be directly contacted by the user.

The output unit 140 outputs the provided data according to the data and a control signal provided from the first controller 110b.

The wireless communication unit 150 may be configured as a mobile communication interface, such as HSPA, WiBro, WiMAX, or a wireless LAN interface, etc. The wireless communication unit 150 may access the Web server 320 through a network 310 to transmit and receive data under the control of the first controller 110b.

Also, when the multimedia data providing device 100b provides multimedia data stored in the external contents server 330, besides the multimedia data stored in the storage unit 120b, to the human body communication device 200b, the wireless communication unit 150 accesses the contents server 330 through the network 310 under the control of the first controller 110b, receives multimedia data from the contents server 330, and provides the received multimedia data to the first controller 110b.

The human body communication device 200b may include a second human body communication unit 210b, a second controller 220b, a multimedia data processing unit 230b, and an input/output unit 240b.

When the user comes into contact with the conductive member installed in the handle 103, the bar 104, or the like, within transportation, the second human body communication unit 210b receives multimedia data transmitted through the user's body, processes the received multimedia data, and provides the processed data to the second controller 220b. To this end, the second human body communication unit 210b includes an electrode (not shown) to be contacted by the user's body.

In addition, the second human body communication unit 210b processes the data provided from the second controller 220b such that it fits human body communication, and transmits the processed data to the user's body through an electrode (not shown).

The second controller 220b receives the multimedia data from the second human body communication unit 210b and provides the received multimedia data to the multimedia data processing unit 230b, and controls the multimedia data processing unit 230b to execute the multimedia data.

Also, the second controller 220b provides the data (e.g., text data) provided from the input/output unit 240b to the second human body communication unit 210b and controls the second human body communication unit 210b to transmit the data to the multimedia data providing device 100b through human body communication.

The multimedia data processing unit 230b executes the provided multimedia data under the control of the second controller 220b, and provides the executed data to the input/output unit 240b. To this end, the multimedia data processing unit 230b may include a decoding module for decoding a coded voice or image data.

The input/output unit 240b may be configured as a keypad, a touch pad, a touch screen, a display element, or the like. The input/output unit 240b provides data generated according to a user's key manipulation to the second controller 220b, or outputs signals provided from the multimedia data processing unit 230b.

For example, when the user inputs an address for accessing a certain Web server through the input/output unit 240b, the input/output unit 240b provides the received address to the second controller 220b, and the second controller 220b provides the Internet access information including the address to the multimedia data providing device 100b through the second human body communication unit 210b. Thereafter, the human body communication unit 200b receives Internet data through the second human body communication unit 210b and outputs the received Internet data through the input/output unit 240b.

As set forth above, the system for providing multimedia data using human body communication in transportation according to exemplary embodiments of the invention provides multimedia data processed to fit human body communication to handles or vertical or horizontal bars within transportation such as buses, subways and the like. Thus, a user carrying around a human body communication device can enjoy music or view video by simply holding the handle or the bar, thus allowing the user to conveniently use various multimedia.

When information created by the user is transmitted to a multimedia data providing device installed in transportation by using bi-directional human body communication, the multimedia data providing device receives and displays the information, thus actively providing user desired information or multimedia contents.

The multimedia data providing device installed in transportation includes a mobile communication interface or a wireless LAN interface. Thus, the multimedia data providing device can serve as an access point over an external network and communicates with the user through human body communication within transportation, thus providing an Internet service at a very low cost.

While the present invention has been shown and described in connection with the exemplary embodiments, it will be apparent to those skilled in the art that modifications and variations can be made without departing from the spirit and scope of the invention as defined by the appended claims.

What is claimed is:

1. A system for providing multimedia data using human body communication in transportation, the system comprising:
a first controller acquiring multimedia data and providing acquired multimedia data;
a first human body communication unit converting the multimedia data into a signal available for human body communication and then providing the converted signal to one or more conductive members installed In transportation; and
a storage unit storing the multimedia data.

2. The system of claim 1, wherein the first controller provides control to provide different types of multimedia data to each of the one or more conductive members installed in transportation.

3. The system of claim 1, further comprising:
an output unit displaying data provided through human body communication,
wherein when data is provided through human body communication, the first controller controls the output unit to display the provided data.

4. The system of claim 1, wherein the one or more conductive members are installed in at least one of a handle, vertical bar and horizontal bar installed within transportation.

5. The system of claim 1, further comprising:
a wireless communication unit performing radio communication under the control of the first controller.

6. The system of claim 5, wherein when Internet access information is provided, the first controller provides control to access a corresponding server via the wireless communication unit and transmits data provided from the corresponding server through human body communication.

7. A system for providing multimedia data using human body communication in transportation, including:
a second human body communication unit receiving multimedia data transmitted through a user's body and providing the received multimedia data;
a second controller receiving the multimedia data and controlling the execution of the received multimedia data; and
a multimedia data processing unit executing the multimedia data under the control of the second controller.

8. The system of claim 7, further comprising:
an input unit receiving data from a user; and
an output unit outputting execution results of the multimedia data,
wherein when data is provided through the input unit, the second controller controls the second human body communication unit to transmit the provided input data through human body communication.

9. A system for providing multimedia data using human body communication in transportation, the system comprising:
a multimedia data providing device converting multimedia data into a signal available for human communication and transmitting the converted signal to one or more of conductive units installed within transportation; and
a human body communication device receiving the multimedia data through a user's body brought into contact with the one or more conductive units and executing the received multimedia data.

10. The system of claim 9, wherein the human body communication device converts information provided from a user into a signal available for human body communication and provides the converted signal to the one or more conductive units brought into contact with the user's body.

11. The system of claim 9, wherein the multimedia data providing device accesses a corresponding Web server according to Internet access information provided from the human body communication device, converts data provided from the accessed Web server into a signal available for human body communication, and provides the converted signal to the human body communication device.
